(19) United States
(12) Patent Application Publication
(10) Pub. No.: US 2002/0166299 A1
(43) Pub. Date: Nov. 14, 2002

(54) Door frame

(76) Inventor: Robert H. Day, Camarillo, CA (US)

Correspondence Address: Sheldon & Mak, 9th Floor, 225 South Lake Avenue, Pasadena, CA, 91101, US

(21) Appl. No.: 09/851,906

(22) Filed: May 9, 2001

(51) Int. Cl. E06B 1/04

(52) U.S. Cl. 52/211; 52/212; 52/287.1; 52/717.01; 49/505

(57) ABSTRACT

The invention is a is a pre-manufactured casing assembly for a wall opening that is assembled to form a unitary casing structure that does not disengage or separate at corners over time and prolonged usage. The corners of the casing assembly are rigidly held in place by corner connectors that are attached to the individual casing pieces by attachment means.

### BACKGROUND

This invention relates generally to door and window frames, and more specifically to prefabricated casing and molding structures for doors and window frames.

Metal frames and moldings for doors and windows have been widely used for some time, and were originally described in U.S. Pat. No. 3,107,759 entitled PREFABRICATED DOOR FRAME AND MOLDING STRUCTURE, which issued on Oct. 22, 1963 to Robert L. Day and Harry L. Williams. These popular moldings, also commonly known and referred to hereinafter as casings, are pre-fitted and pre-manufactured at a factory as individual pieces that are later assembled at a construction site.

Current casing structures have corner connectors that are intended to hold the mitered corners together. However, the effectiveness of these prior art corner connectors is compromised because they are designed to be reversibly attached to the casing pieces to allow the structure to be adjusted upon assembly. A resulting problem is that the individual casing pieces of the structure can become separated at corners over time and repeated use.

One particular problem is that the vertical casing members tend to move downward with time due to the effect of gravity, building settling, and repeated and prolonged door closings. This causes the mitered corners formed by the abutment of two casing members to separate. As individual casing pieces move from their original intended position, the integrity of the entire casing structure is weakened because adjacent casing members help sustain the position of one another.

What is needed is casing structure that is pre-manufactured, adjustable, and yet can be assembled to provide a unitary casing structure that does not disengage or separate at corners over time and prolonged usage.

### SUMMARY

The invention satisfies this need. The invention is a casing assembly for a wall opening that, upon assembly, provides a unitary casing structure that does not disengage or separate at corners over time and prolonged usage. The casing assembly of the invention also retains the benefits of prior art casing assemblies in that it is pre-manufactured and is adjustable.

The casing assembly comprises a plurality of casing members to be interconnected to form a framed casing having at least one corner. The casing members are channel shaped, and have a casing surface wall connected to two opposed casing side walls. Each casing member has two opposed open ends. The casing assembly further comprises at least one corner connector. Each corner connector comprises two male connectors that are disposed at about a 90 degree angle to one another. The male connector is configured to engage with and plug into one of the open ends of the casing members. The casing assembly further comprises attachment means for fixedly attaching at least one male connector in one of the open ends of one of the casing members before the casing members are assembled together. The attachment means prevents the casing members from disengagement after assembly.

In another embodiment, the invention is a unitized casing assembly for a wall opening wherein the above described casing members are attached to frame members. The frame members are interconnected and attached to a wall opening having at least three longitudinal edges. The frame members comprise a jamb surface wall having two opposing lateral edges. Each lateral edge of the jamb surface wall is interconnected to a frame side wall at about a 90 degree angle. Each frame side wall is configured to lie flat along a surface adjacent to a wall opening. The frame member side walls have integral clip holders that are spaced apart a predetermined distance from the lateral edge of the jamb surface wall. The unitized casing assembly further comprises a series of casing clips that upon assembly fit into and are rigidly secured by the clip holders. The casing members are then attached to a frame side wall by the casing clips. Upon assembly, the attachment of corner connectors to casing members by the attachment means maintains the position of the casing members along an axis parallel to the longitudinal wall opening edge. The casing clips maintain the position of the casing members in an axis perpendicular to the longitudinal wall opening edge. The attachment means and the casing clips, in combination, provide a unitized casing assembly that is substantially free from disengaging at the corners and a casing assembly that is rigid disposed relative to the wall opening.

### DRAWINGS

These features, aspects and advantages of the present invention will become better understood with regard to the following description, appended claims and accompanying figures where:

FIG. 1 is a perspective view a framed casing according to the present invention shown assembled in a door opening;

FIG. 2 is an enlarged perspective view of the framed casing of FIG. 1;

FIG. 3 is a perspective view of a corner connector according to the present invention;

FIG. 4 is a perspective view of a corner connector according to the present invention shown in engaging alignment with two casing members;

FIG. 5 is a perspective view of a corner connector according to the present invention shown plugged into a casing member and fixedly attached to the casing member by crimps in the casing member;

FIG. 6 is a perspective view of a corner connector according to the present invention shown with one male connector plugged into a casing member and the other male connector shown in engaging alignment with a second casing member;

FIG. 7 is a perspective view of a unitized casing assembly according to the present invention shown partially assembled;

FIG. 8 is a cross-section of the corner connector and casing member of FIG. 5 taken along line 8-8 in FIG. 5;

FIG. 9 is a perspective view of an embodiment of a corner connector of the present invention having a dimpled depression;

FIG. 10 is a perspective view of the corner connector of FIG. 9 shown with one male connector engaging with a casing member and the second male connector in alignment with a second casing member;

FIG. 11 is a perspective view of a corner connector mounted in a corner of a casing assembly according to the present invention shown; and

FIG. 12 is a cross-section of the corner connector of FIG. 11, taken along line 1212.

### DESCRIPTION

The following discussion describes in detail two embodiments of the invention and several variations of these embodiments. This discussion should not be construed, however, as limiting the invention to those particular embodiments. Practitioners skilled in the art will recognize numerous other embodiments as well. In all of the embodiments described herein that are referred to as being preferred or particularly preferred, these embodiments are not essential even though they may be preferred.

The invention is a casing assembly 10 for a wall opening 12 comprising a plurality of casing members 14 that are interconnected at corners 16 by corner connectors 18 to form a framed casing 20.

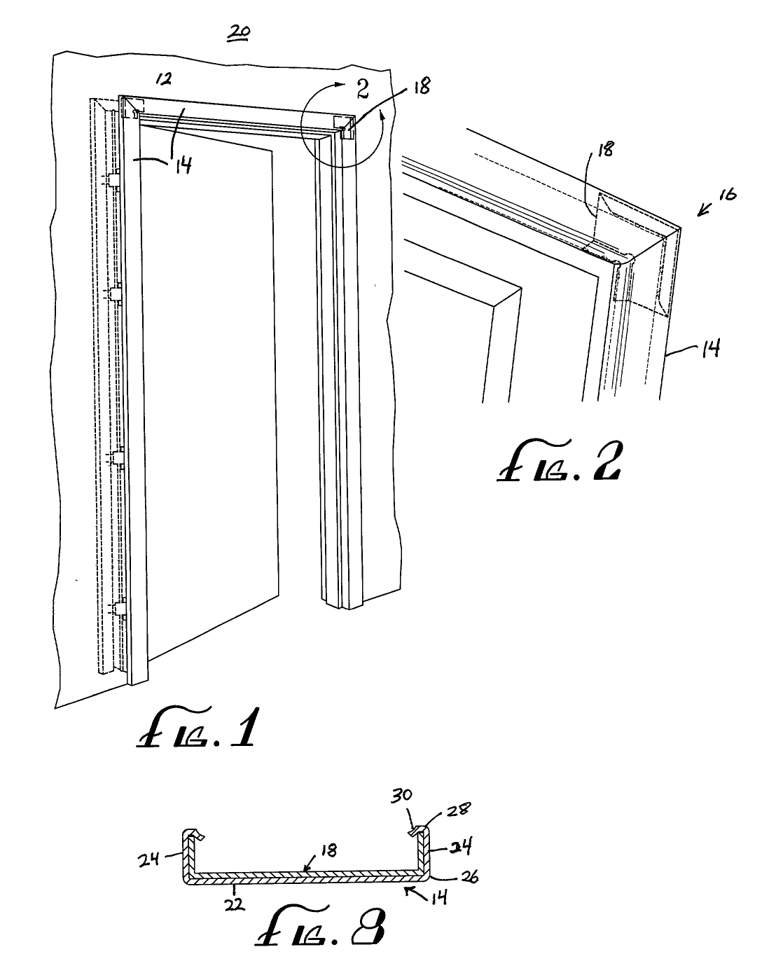

The framed casing 20 has at least one corner 16. In the embodiment illustrated in FIG. 2, the framed casing 20 has two corners 16 on each surface of the wall opening 12. In the embodiment illustrated in FIG. 1, the casing assembly 10 comprises a header casing member 14 and two vertical casing members 14. Upon assembly, the header casing member 14 is disposed horizontally and each vertical casing member 14 is connected to the header casing member 14 at a corner 16. In alternative embodiments (not shown), the framed casing 20 is configured to mount into a window opening and the framed casing 20 has four corners 16 on each side of the wall opening 12. In still alternative embodiments (not shown), the framed casing 20 is configured to mount into a door or window opening with one or more sidelites or partial sidelites, and the framed casing 20 comprises six or more corners 16 on each side of a wall opening 12.

As shown in the embodiment in FIG. 8, each casing member 14 is generally channel shaped and comprises a casing surface wall 22 connected to two opposed casing side walls 24. The casing members 14 have an inner channel surface and an outer surface. The casing surface wall 22 of each casing member 14 has two opposed lateral edges. In the embodiments illustrated in the drawings, the casing surface wall 22 is substantially planar and generally rectangular. In alternative embodiments (not shown), the casing surface wall 22 is not entirely planar and the casing members 14 have a beveled, molded, or otherwise decorative shaped surface. The term casing members 14 as used herein includes molding, trim, and similar such articles. The casing members 14 are typically formed of wood, plastics, and metals such as aluminum, brass, steel, and alloys. In a preferred embodiment, the casing members 14 are made from cold rolled steel sheet metal. The casing members 14 can be coated with a decorative finish such as, for example, a baked enamel.

Each casing side wall 24 of a casing member 14 has a connecting edge 26 and a free edge 28. As illustrated in FIG. 8, each lateral edge of the casing surface wall 22 is interconnected or attached with the connecting edge 26 of a casing side wall 24. In the embodiments illustrated in the drawings, each side wall 24 of the casing members 14 further comprises a rim 30. As illustrated in FIGS. 4, 5, 6, and 8, each rim 30 is attached to and interconnected with the free edge 28 of a casing side wall 24, and each rim 30 is disposed in a plane that is substantially in parallel to the plane of the casing surface wall 22 of that particular casing member 14.

As illustrated in FIG. 1, each casing member 14 has two opposed open ends 32. In preferred embodiments, an open end 32 from at least two separate casing members 14 is mitered at an angle. In embodiments having mitered open ends 32, the abutting open ends 32 are mitered at angles to cooperate with one another to form a corner 16 having a desired angle. Typically the open ends 32 to be in abutment are mitered at and angle of between about 30 degrees and about 60 degrees, and when abutted together the two casing members 14 form a 90 degree corner 16. In preferred embodiments, the open ends 32 of at least two casing members 14 are mitered at an angle of about 45 degrees such that upon assembly and abutting the two together they form a 90 degree corner 16. For example, a casing assembly 10 for a framed door opening has two vertical casing members 14 and the open end 32 of the vertical casing member 14 which is upwardly disposed is mitered but the downwardly disposed open end 32 is not mitered, and in contrast the horizontally disposed header casing member 14 is mitered at both open ends 32.

The casing assembly 10 further comprises at least one corner connector 18. With reference to FIGS. 3-5, each corner connector 18 comprises two male connectors 34 that are disposed at about a 90 degree angle relative to one another. Each male connector 34 is configured to engage with and plug into one of the open end 32 of the casing members 14. In the embodiment of the corner connector 18 illustrated in FIGS. 3-6, each male connector 34 comprises three interconnected connector surface walls that are configured to slidably engage with the casing surface wall 22 and opposed casing surface walls 22 of a casing member 14 when a male connector 34 is plugged into an open end 32 of a casing member 14.

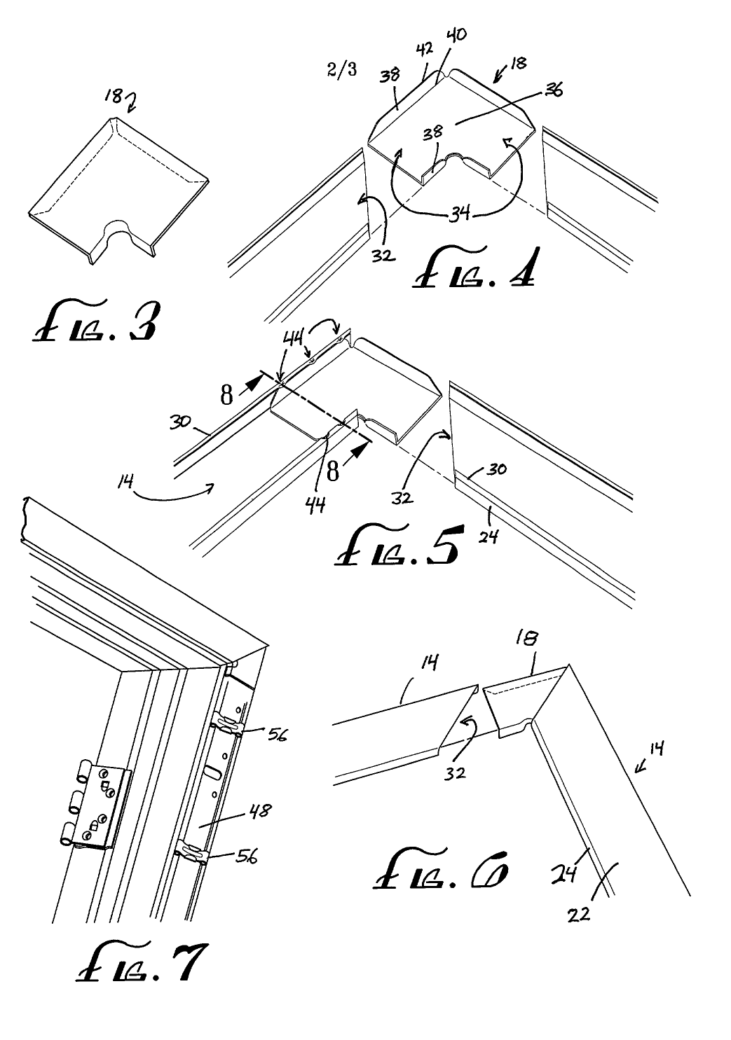

With reference to the embodiment of the corner connector 18 illustrated in FIGS. 4 and 5, each male connector 34 comprises a connector bottom wall 36, a first male connector side wall 38, and a second male connector side wall 38. The connector bottom wall 36 comprises two lateral edges. Each male connector side wall 38 comprises a connecting edge 40 and a free edge 42, with the connecting edge 40 of the first male connector side wall 38 being connected to one lateral edge of the connector bottom wall 36 at about a 90 degree angle, and the connecting edge 40 of the second male connector side wall 38 being connected to the other lateral edge of the connector bottom wall 36 at about a 90 degree angle.

The casing assembly 10 further comprises attachment means 44 for fixedly attaching at least one male connector 34 in one of the open end 32 of one of the casing members 14 before the casing members 14 are assembled. The attachment means 44 functions to prevent the casing members 14 from disengagement at abutted corners 16. In the embodiment illustrated in FIG. 5 and FIG. 8, the side walls of the molding members have rims 30 and the attachment means 44 comprises at least one crimp 44 on a rim 30 that presses against a male connector 34 plugged into an open end 32. The at least one crimp 44 acts to fixedly attach the male connector 34 in the open end 32. In alternative embodiments (not shown), the attachment means 44 comprises other forms of attachment such as attachment of a casing member 14 to a corner connector 18 by spot welding or soldering, attachment of a casing member 14 to a corner connector 18 with a glue or adhesive, by compression of a portion of a molding member against a corner connector, or by riveting.

In a preferred embodiment, the casing members 14 are interconnected to form a framed casing 20 wherein only one male connector 34 of each corner connector 18 is fixedly attached to an open end 32 of a casing member 14. In another preferred embodiment, a first male connector 34 of a corner connector 18 is plugged into an open end 32 of at least one vertical casing member 14 and fixedly attached in the open end 32 of the vertical casing member 14 prior to plugging the second male connector 34 of the corner connector 18 into a horizontal casing member 14 and prior to completing assembly of the casing assembly 10.

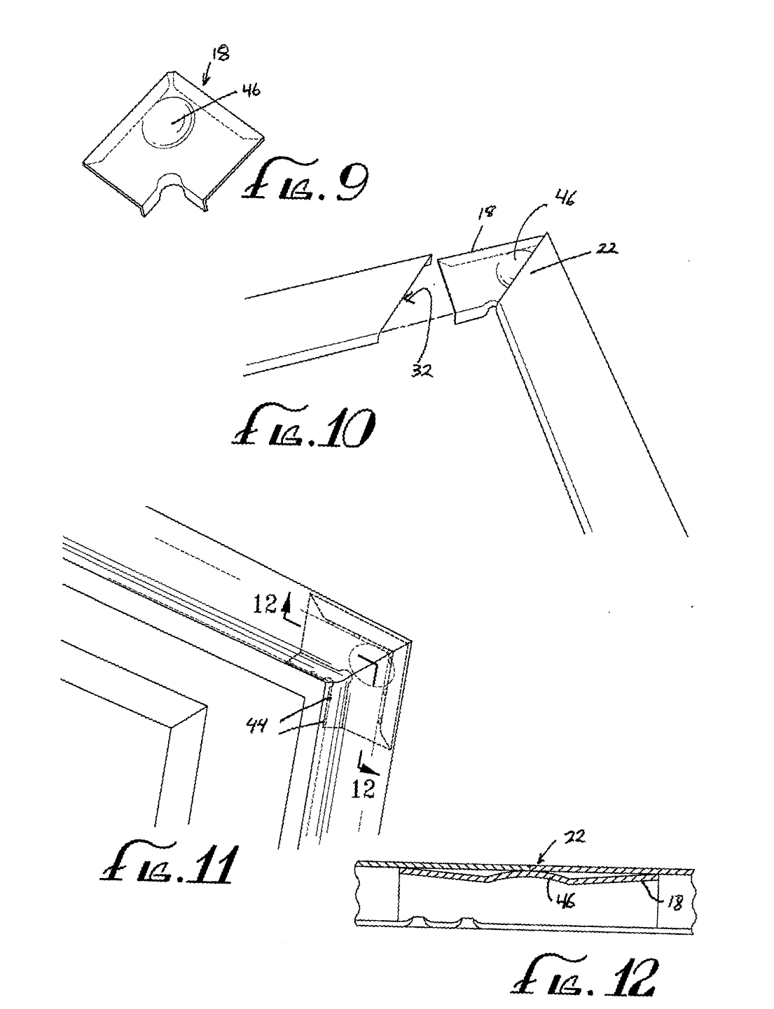

In the embodiment illustrated in FIGS. 9-12, the corner connector 18 further comprises a dimpled depression 46. The dimpled depression 46 abuts against two casing member surface walls 22 when the male connectors 34 of a corner connector 18 are plugged into the open ends 32 of two casing members 14 at a corner 16.

With reference to FIGS. 1 and 7, another embodiment of the invention is a unitized casing assembly 10 for a wall opening 12. The unitized casing assembly 10 comprises frame members 48 that are interconnected in a wall opening 12 and attached to the wall opening 12. The wall opening 12 comprises at least three longitudinal edges. A wall opening 12 for a door has three longitudinal edges, two being vertical and one being horizontal. A wall opening 12 for a window typically has four longitudinal edges, two being vertical and two being horizontal. A wall opening 12 for a door or window having a sidelite will have a number of additional longitudinal edges that depends on the particular configuration.

Each frame member 48 comprises a jamb surface wall 50 having two opposing lateral edges. Each lateral edge of a jamb surface wall 50 is interconnected to a frame side wall 52 at about a 90 degree angle. As illustrated in FIG. 1, each frame side wall 52 is configured to lie flat along a wall surface adjoining a wall opening 12.

As illustrated in FIG. 7, the frame side walls 52 comprise clip holders 54 that are integral with the frame side wall 52. Preferably, the clip holders 54 are spaced apart a predetermined distance from the lateral edge of the jamb surface wall 50. The clip holders 54 are configured to hold a series of casing clips 56 that are fitted into the clip holders 54 and rigidly secured to the clip holders 54.

The casing members 14 are attached to the frame side walls 52 by engagement with the casing clips 56. Typically the casing members 14 are disposed and attached substantially in-parallel to the longitudinal axis of a frame member 48 that is disposed in-parallel to a proximal wall opening 12 edge. The casing clips 56 have rounded ends that facilitate the engagement of the casing members 14 with the casing clips 56 upon assembly. The casing clips 56 are configured to have a width substantially similar to the width of the casing members 14 such that, upon assembly, they firmly press against the inner surface of the casing member 14.

The casing clips 56 maintain the position of the casing members 14 in an axis perpendicular to the longitudinal wall opening 12 edge. The casing clips 56 also provide some degree of positional maintenance to the casing members 14 along an axis parallel to the longitudinal wall opening 12 edge, but not enough to prevent the casing members 14 from moving or sliding in either direction parallel to the longitudinal wall opening 12 edge if sufficient force is applied.

The problem of separation of mitered corners 16 is solved by the attachment means 44. The attachment means 44 functions to fixedly attach a male connector 34 in one of the open end 32 of a casing member 14 before the casing members 14 are assembled. The attachment means 44 maintains the position of the casing members 14 along an axis parallel to the longitudinal wall opening 12 edge and prevents the casing members 14 from disengaging upon assembly. The attachment means 44 and the casing clips 56 function synergistically to provide a unitized casing assembly 10 that is firmly supported in horizontal and vertical direction. The attachment means 44 and casing clips 56, when functioning together, also firmly retain the casing assembly 10 in all directions relative to the plane of the wall opening 12.

The invention further includes a method of forming a framed casing 20 comprising the steps of selecting a casing assembly 10 described herein; plugging a male connector 34 into an open end 32 of a casing member 14; fixedly attaching the male connector 34 within the casing member 14; and assembling together the casing members 14 so they do not disengage from each other. A particularly preferred method according to the invention further comprises the steps of selecting a casing assembly 10 having at least two separate casing members 14 that are mitered at an angle of about 45 degrees, after plugging a male connector 34 into a vertical casing member 14, fixedly attaching the corner connector 18 in the vertical casing member 14; and assembling together the casing members 14 such that the mitered corners 16 are held together tightly in a fixed position relative to each other.

In installing a typical casing assembly 10, the components such as the casing members 14, frame members 48, and corner connectors 18, are pre-fitted and pre-manufactured at a factory and brought to the assembly site. The casing members 14 are fixedly attached to the corner connectors 18 by the attachment means 44, either on site or at the factory. In the preferred embodiment, in which the open end 32 are mitered, it is important that the corner connectors 18 are plugged into the open end 32 a suitable distance to ensure a tight miter before attachment by the attachment means 44. After the wall opening 12 has been inspected to verify that the opening sizes and wall thicknesses are acceptable, the frame members 48 are fitted, aligned, and anchored in the wall opening 12. Where the assembly is for a door frame, the upper horizontal casing member 14 is first attached to the horizontal frame member by pressing or popping the casing member 14 onto casing clips 56 that have previously been attached to the frame member. The vertical casing members 14, which have a corner connector 18 attached to their upper open end 32 by the attachment means 44, are pulled a slight distance away from the casing clips 56 protruding from the horizontal frame members 48, and simultaneously plugged into the open end 32 of the horizontal header casing member 14.

Having thus described the invention, it should be apparent that numerous structural modifications and adaptations may be resorted to without departing from the scope and fair meaning of the instant invention as set forth hereinabove and as described hereinbelow by the claims.

Although the present invention has been described in considerable detail with reference to certain preferred versions thereof, other versions are possible. For example, although the attachment means 44 typically comprises crimping, other attachment means such as welding, soldering, adhesives, by compression, or riveting may be substituted. Therefore, the spirit and scope of the appended claims should not be limited to the description of the preferred versions described herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. A casing assembly for a wall opening, the casing assembly comprising:
(a) a plurality of casing members to be interconnected to form a framed casing having at least one corner, each casing member being channel shaped with a casing surface wall connected to two opposed casing side walls, and wherein each casing member has two opposed open ends;
(b) at least one corner connector comprising two male connectors generally disposed at about a 90 degree angle to one another, wherein each male connector is configured to engage with and plug into one of the open ends of the casing members; and
(c) attachment means fixedly attaching at least one male connector in one of the open ends of one of the casing members before the casing members are assembled together so that when the casing members are assembled they do not disengage from each other.

2. The casing assembly of claim 1 wherein the casing side walls further comprise a rim, and wherein the attachment means comprises at least one crimp on a rim that presses against a male connector plugged into an open end to fixedly attach the male connector in the open end.

3. The casing assembly of claim 1 wherein the casing members are interconnected to form a framed casing wherein only one male connector of each corner connector is fixedly attached to an open end of a casing member.

4. The casing assembly of claim 1 wherein an open end from at least two separate casing members is mitred at an angle of about 45 degrees such that upon assembly at least two casing members are abutted together at a corner at about a 90 degree angle relative to each other.

5. The casing assembly of claim 1 wherein each male connector comprises three interconnected connector surface walls that are configured to slidably engage with the casing surface wall and the casing side walls of a casing member when a male connector is plugged into an open end of a casing member.

6. The casing assembly of claim 1 wherein the casing assembly comprises a header casing member and two vertical casing members, wherein upon assembly the header casing member is disposed horizontally and each vertical casing member is connected to the header casing member at a corner.

7. The casing assembly of claim 6 wherein a male connector of a corner connector is plugged into an open end of at least one vertical casing member and fixedly attached in the open end of the vertical casing member prior to completing assembly of the casing assembly.

8. The casing assembly of claim 1 wherein upon assembly the framed casing has four corners.

9. The casing assembly of claim 1 wherein the casing members are made of roll formed steel.

10. The casing assembly of claim 1 wherein at least one corner connector further comprises a dimpled depression that abuts against two casing member surface walls at a corner.

11. A casing assembly for a wall opening, the casing assembly comprising:
(a) a plurality of casing members to be interconnected to form a framed casing having between two and four corners upon assembly, each casing member being channel shaped with a casing surface wall connected to two opposed casing side walls, wherein each casing member has two opposed open ends, and wherein at least one open end of each casing member is mitred at an angle of about 45 degrees such that upon assembly when two casing members are abutted together at a corner they are disposed at about 90 relative to each other;
(b) at least one corner connector comprising two male connectors generally disposed at about a 90 degree angle to one another, wherein each male connector is configured to engage with and plug into one of the open ends of the casing members; and
(c) attachment means fixedly attaching at least one male connector in one of the open ends of one of the casing members before the casing members are assembled together so that when the casing members are assembled they do not disengage from each other.

12. The casing assembly of claim 11 wherein the casing side walls further comprise a rim, and wherein the attachment means comprises at least one crimp on a rim that presses against a male connector plugged into an open end to fixedly attach the male connector in the open end.

13. The casing assembly of claim 11 wherein each male connector comprises three interconnected connector surface walls that are configured to slidably engage with the casing surface wall and opposed casing side walls of a casing member when a male connector is plugged into an open end of a casing member.

14. A unitized casing assembly for a wall opening, the casing assembly comprising:
(a) frame members to be interconnected in a wall opening, the wall opening having at least three longitudinal edges, each frame member comprising a jamb surface wall, the jamb surface wall having two opposing lateral edges, each lateral edge being interconnected to a frame side wall at about a 90 degree angle, each frame side wall being configured to lie flat along a wall surface adjoining a wall opening, each frame side wall having clip holders integral with the frame side wall and spaced apart a predetermined distance from the lateral edge of the jamb surface wall;
(b) a series of casing clips to be fitted and rigidly secured to the clip holders;
(c) casing members to be attached to a frame side wall by the casing clips, each casing member being channel shaped with a casing surface wall connected to two opposed casing side walls, each casing member has two opposed open ends, and wherein a casing member is disposed substantially in-parallel to a proximal wall opening edge;
(d) at least one corner connector comprising two male connectors generally disposed at about a 90 degree angle to one another, wherein each male connector is configured to engage with and plug into an open end of a casing member;
(e) attachment means fixedly attaching at least one male connector in one of the open ends of one of the casing members before the casing members are assembled together so that when the casing members are assembled they do not disengage from each other; and
(f) wherein after assembly the attachment of corner connectors to casing members by the attachment means maintains the position of the casing members along an axis parallel to the longitudinal wall opening edge and the casing clips maintain the position of the casing members in an axis perpendicular to the longitudinal wall opening edge, and wherein the combination of the attachment means and the casing clips provides a unitized casing assembly that is substantially free from disengaging at the corners and is held in the casing assembly is rigid disposed relative to the wall opening.

15. The unitized casing assembly of claim 14 wherein the casing assembly comprises a header casing member and two vertical casing members, wherein upon assembly the header casing member is disposed horizontally and each vertical casing member is connected to the header casing member at a corner.

16. The casing assembly of claim 15 wherein a male connector of a corner connector is plugged into an open end of a vertical casing member and fixedly attached in the open end of the vertical casing member prior to completing assembly of the casing assembly.

17. The casing assembly of claim 14 wherein the casing side walls further comprise a rim, and wherein the attachment means comprises at least one crimp on a rim that presses against a male connector plugged into an open end to fixedly attach the male connector in the open end.

18. The casing assembly of claim 14 wherein at least one open end from at least two separate casing members is mitred at an angle of about 45 degrees such that upon assembly at least two casing members are abutted together at a corner at about a 90 degree angle relative to each other.

19. The casing assembly of claim 14 wherein each male connector comprises three interconnected connector surface walls that are configured to slidably engage with the casing surface wall and the opposed casing side walls of a casing member when a male connector is plugged into an open end of a casing member.

20. A method of forming a framed casing comprising the steps of:
(a) selecting the casing assembly of claim 1;
(b) plugging a male connector into an open end of a casing member;
(c) fixedly attaching the male connector within the casing member; and
(d) assembling together the casing members so they do not disengage from each other.

21. A method of forming a framed casing comprising the steps of:
(a) selecting the casing assembly of claim 18;
(b) plugging a male connector into an open end of a casing member;
(c) fixedly attaching the male connector within the casing member; and
(d) assembling together the casing members such that the mitred corners are held together tightly in a fixed position relative to each other.
